(19) United States
(12) Patent Application Publication
(10) Pub. No.: US 2022/0003919 A1
(43) Pub. Date: Jan. 6, 2022

(54) BACKLIGHT APPARATUS

(71) Applicant: SAKAI DISPLAY PRODUCTS CORPORATION, Sakai-shi, Osaka (JP)

(72) Inventors: Risa SUNO, Sakai-shi, Osaka (JP); NAOKI HOSOYA, Sakai-shi, Osaka (JP); HIROKI AZUMA, Sakai-shi, Osaka (JP); YOSHIKI MATAKA, Sakai-shi, Osaka (JP)

(21) Appl. No.: 17/293,871

(22) PCT Filed: Nov. 14, 2018
(86) PCT No.: PCT/JP2018/042128

§ 371 Date: May 13, 2021

(51) Int. Cl. F21V 8/00

(52) U.S. Cl. CPC G02B 6/0088; G02B 6/0055

(57) ABSTRACT

A backlight apparatus 1 comprises a light guiding plate 2 having a front surface 21, a rear surface 22, and an end face 23; a light source portion 3 comprising a plate-shaped light source substrate 31 extending substantially parallel to the rear surface 22 of the light guiding plate 2 and having a front surface 31a and a rear surface 31b, and a light source 32 provided on the light source substrate 31 so as to face the end face 23 of the light guiding plate 2; a backlight chassis 4 arranged facing the rear surface 31b of the light source substrate 31 and having a front surface 41 and a rear surface 42; and a fixing member 5 to sandwich and fix the light guiding plate 2, the light source substrate 31, and the backlight chassis 4 in a thickness direction of the light guiding plate 2.

### TECHNICAL FIELD

The invention relates to a backlight apparatus.

### BACKGROUND ART

A display apparatus such as a liquid crystal display apparatus, for example, to display an image on an image display portion such as a liquid crystal panel by irradiating light toward the image display portion from a backlight apparatus is known. As such a backlight apparatus, a direct-type backlight apparatus in which light sources are uniformly arranged immediately below a liquid crystal panel and an edge light-type backlight apparatus in which a light source is arranged along an end face of a light guiding plate are known.

In the edge light-type backlight apparatus, the light source is arranged along the end face of the light guiding plate, making it possible to thin the display apparatus. For example, Patent document 1 discloses an edge light-type backlight apparatus in which a light source is mounted to a supporting member having a U-shaped cross section. The above-mentioned backlight apparatus of Patent document 1 has a supporting member having a bottom portion and lateral wall portions extending in a direction orthogonal to the bottom portion, and a light source substrate is assembled to the bottom portion of the supporting member with a screw or a double-sided tape.

### PRIOR ART DOCUMENT

Patent Document
Patent Document 1: WO2017/126034A

### SUMMARY OF THE INVENTION

### Problem to be Solved by the Invention

In a case of the structure of Patent document 1, the light source substrate is mounted to the bottom portion of the supporting member. Therefore, in addition to a space for the light source, a space corresponding to the thickness of the light source substrate supporting the light source is required in a direction perpendicular to the end face of the light guiding plate. Accordingly, narrowing of a bezel of a display apparatus is difficult. Moreover, in Patent document 1, to prevent positional displacement between the light guiding plate and the light source, the light source must be fixed onto the inner surface of the supporting member having a U-shaped cross section with a screw or a double-sided tape.

In recent years, a further thinning of the display apparatus is required, and the light guiding plate becomes thinner and the light source becomes smaller. Accordingly, in a structure shown in Patent document 1, in case that a fixing position of the light source relative to the supporting member is displaced or a position of the light guiding plate relative to the supporting member is displaced, a loss in luminous flux due to a displacement of the optical axis or the like might be caused. Moreover, in case that the light source becomes smaller, assembling between the light source and the supporting member would be difficult and workability would be reduced.

Thus, in light of such problems, an object of the invention is to provide a backlight apparatus that makes it possible to suppress positional displacement of the optical axis of a light source relative to a light guiding plate and that makes it possible to improve the workability at the time of assembling of components of the backlight apparatus.

### Means to Solve the Problem

A backlight apparatus according to one embodiment of the invention comprises a light guiding plate having a front surface, a rear surface, and an end face connecting the front surface and the rear surface; a light source portion comprising a plate-shaped light source substrate extending substantially parallel to the rear surface of the light guiding plate and having a front surface and a rear surface and a light source provided on the light source substrate so as to face the end face of the light guiding plate; a backlight chassis arranged facing the rear surface of the light source substrate and having a front surface and a rear surface; and a fixing member to sandwich and fix the light guiding plate, the light source substrate, and the backlight chassis in a thickness direction of the light guiding plate.

### Effects of the Invention

A backlight apparatus according to the invention makes it possible to suppress positional displacement of the optical axis of a light source relative to a light guiding plate and makes it possible to improve the workability at the time of assembling of components of the backlight apparatus.

### BRIEF DESCRIPTION OF THE DRAWINGS

FIG. 1 shows a schematic perspective view of the external appearance of a display apparatus comprising a backlight apparatus according to one embodiment of the invention.

FIG. 2 shows a schematic cross-sectional view along a line II-II of FIG. 1.

FIG. 3 shows a schematic perspective view showing a layered body of a light guiding plate, a light source portion, and a backlight chassis before a fixing member is mounted thereto in the backlight apparatus according to one embodiment of the invention.

FIG. 4 shows a schematic perspective view showing a state in which a rear surface of the backlight chassis is in contact with a front surface of a second sandwiching portion of the fixing member in the backlight apparatus according to one embodiment of the invention.

FIG. 5 shows a schematic perspective view showing a state in which the fixing member is mounted to the layered body in the backlight apparatus according to one embodiment of the invention.

FIG. 6 shows a schematic cross-sectional view of the display apparatus comprising the backlight apparatus according to Embodiment 2 of the invention.

FIG. 7 shows a schematic perspective view showing a state in which the fixing member is mounted to the layered body in the backlight apparatus according to Embodiment 2.

FIG. 8 shows a schematic cross-sectional view showing a state in which the rear surface of the backlight chassis is in contact with the front surface of the second sandwiching portion of the fixing member in the backlight apparatus according to Embodiment 2.

FIG. 9 shows a schematic cross-sectional view showing a state in which an end face of the light guiding plate passes an opening of the fixing member in the backlight apparatus according to Embodiment 2.

FIG. 10 shows a schematic cross-sectional view showing a state in which a corner portion of the light guiding plate abutting an inclined surface of a projecting portion of the fixing member in the backlight apparatus according to Embodiment 2.

FIG. 11 shows a schematic cross-sectional view showing a state in which the fixing member is mounted to the layered body in the backlight apparatus according to Embodiment 2.

### EMBODIMENT FOR CARRYING OUT THE INVENTION

### Embodiment 1

Below, a backlight apparatus according to one embodiment of the invention will be explained with reference to the drawings. The backlight apparatus of the invention is not to be limited to the embodiments below.

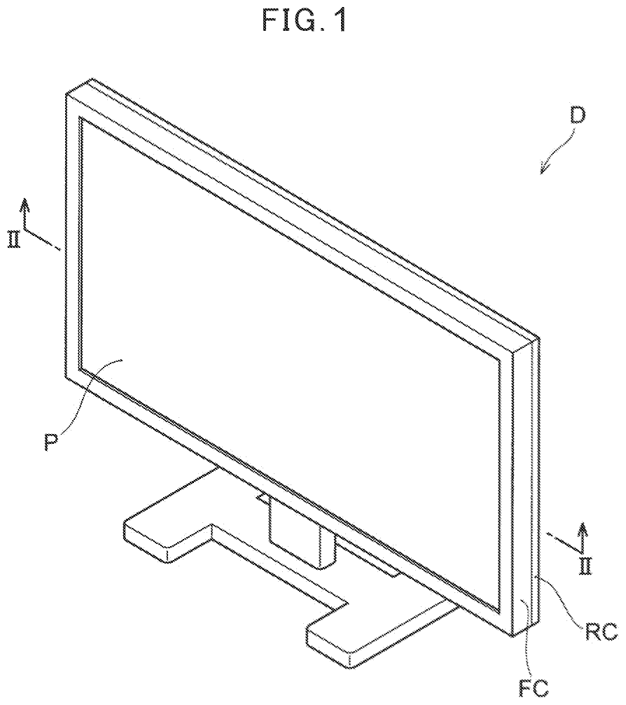

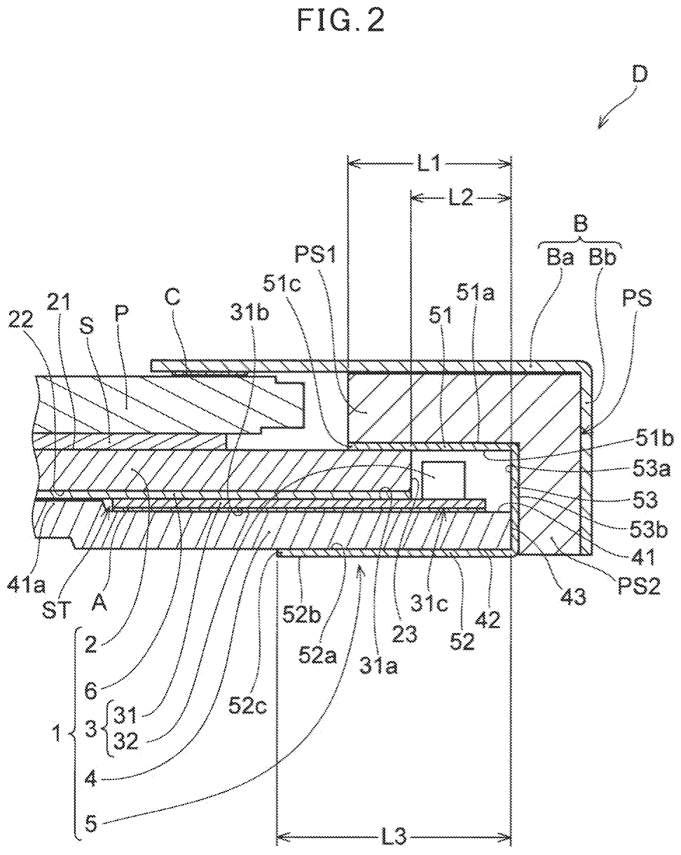

FIG. 1 is a schematic perspective view of the external appearance of a display apparatus comprising the backlight apparatus according to one embodiment of the invention, and FIG. 2 is a cross-sectional view along a line II-II of FIG. 1. According to the embodiment, a display apparatus D is a liquid crystal display apparatus and, as shown in FIGS. 1 and 2, comprises a rectangular plate-shaped display panel (liquid crystal panel) P; and a backlight apparatus 1 (see FIG. 2) to emit light to the display panel P. As shown in FIG. 1, the outer periphery portion of the display panel P is covered by a rectangular frame-shaped front cabinet FC such that the display surface of the display panel P is exposed. In the rear of the backlight apparatus 1, a rear cabinet RC is provided, and a rear surface of the backlight apparatus 1 is covered by the rear cabinet RC.

Herein, a direction in which an image of the display apparatus D is displayed is referred to as front, a direction opposite to the direction in which the image is displayed is referred to as rear, and both directions being the front and the rear are referred to as front and rear direction. Moreover, a surface in the front of each component of the display apparatus D or the backlight apparatus 1 is referred to as a front surface, while a surface opposite to the front surface is referred to as a rear surface. Furthermore, with respect to each component of the display apparatus D or the backlight apparatus 1, a direction approaching the center of the front surface or the rear surface is referred to as inward, while a direction opposite to inward is referred to as outward.

According to the embodiment, as shown in FIG. 2, the display apparatus D comprises a bezel B, the display panel P, an optical sheet S, a panel chassis PS, and the backlight apparatus 1. Moreover, the backlight apparatus 1 comprises a light guiding plate 2, a light source portion 3, a backlight chassis 4, and a fixing member 5. Illustration of the front cabinet FC and the rear cabinet RC is omitted in FIG. 2.

The bezel B is a substantially rectangular frame-shaped member being located in the front of the display apparatus D. As shown in FIG. 2, the bezel B has a frame-shaped frame portion Ba extending parallel to a front surface of the display panel P and covering the outer periphery portion of the front surface of the display panel P; and a lateral wall portion Bb extending perpendicularly to the frame portion Ba from the outer periphery of the frame portion Ba and extending toward the rear of the display apparatus D. An opening being rectangular is formed inner to the frame portion Ba of the bezel B, through the space of the opening an image displayed in a display region of the display panel P is displayed.

The display panel P is a rectangular panel to display an image thereon. The display panel P is arranged rearward of the frame portion Ba of the bezel B and frontward of the optical sheet S. The display panel P has the front surface to display an image thereon and a rear surface being a surface opposite to the front surface. The outer periphery portion of the front surface of the display panel P faces a rear surface of the frame portion Ba of the bezel B, while the rear surface of the display panel P faces a front surface of the optical sheet S. According to the embodiment, a cushioning member C is provided between the outer periphery portion of the front surface of the display panel P and the rear surface of a frame portion Ba of the bezel B.

The display panel P, illustration of which is omitted, has, for example, a TFT substrate, an opposing substrate opposing the TFT substrate, and a liquid crystal layer provided between the TFT substrate and the opposing substrate. As long as the display panel P can display an image thereon, the structure thereof is not particularly limited, so that it can be configured to be similar to a known liquid crystal panel.

The optical sheet S scatters and collects light from a light source 32 of the backlight apparatus 1 to emit uniform light toward the display panel P. The optical sheet S is rectangular and has a front surface facing the rear surface of the display panel P and a rear surface being a surface opposite thereto. According to the embodiment, light emitted via the light guiding plate 2 from the light source 32 of the backlight apparatus 1 enters from the rear surface of the optical sheet S. The light entered from the rear surface of the optical sheet S is scattered and collected by the optical sheet S to be emitted in a uniform luminance distribution toward the rear surface of the display panel P from the front surface of the optical sheet S. For the optical sheet S, a known optical sheet having the above-described function may be used.

According to the embodiment, the panel chassis PS is provided in the rear of the frame portion Ba of the bezel B and inner to the lateral wall portion Bb of the bezel B. The panel chassis PS is formed in a frame shape along the bezel B. As shown in FIG. 2, the panel chassis PS has a front portion PS1 arranged between the frame portion Ba of the bezel B and the fixing member 5 in the front and rear direction; and a lateral portion PS 2 arranged between the lateral wall portion Bb of the bezel B and the fixing member 5. The bezel B and the panel chassis PS are mutually fixed by a fixing portion (not shown) such as a locking claw, for example.

The backlight apparatus 1 emits light from the light source 32 toward a rear surface of a display panel 1 to display an image on the display panel P. According to the embodiment, the backlight apparatus 1 is of the edge light-type and comprises the light guiding plate 2, the light source portion 3, the backlight chassis 4, and the fixing member 5.

The light guiding plate 2 emits light entered from the light source 32 toward the display panel P. The light guiding plate 2 is formed in a rectangular flat plate shape according to the embodiment and, as shown in FIG. 2, has a front surface 21, a rear surface 22, and an end face 23 connecting the front surface 21 and the rear surface 22. The light guiding plate 2 internally scatters light emitted from the light source 32 and entered into the end face 23 of the light guiding plate 2 and emits the scattered light toward the display panel P from the front surface 21.

According to the embodiment, a reflecting plate 6 is provided in the rear of the rear surface 22 of the light guiding plate 2. The reflecting plate 6 reflects light advancing toward the rear surface 22 of the light guiding plate 2 to advance the light toward the front surface 21. The reflecting plate 6 is formed with a synthetic resin having a high reflectance, for example. According to the invention, the reflecting plate 6 is an arbitrary component, so that the reflecting plate 6 does not have to be provided in particular as long as the light guiding plate 2 has a reflection function.

The light source portion 3 is provided along at least one side of the light guiding plate 2 and emits light toward the end face 23 of the light guiding plate 2. As shown in FIG. 2, the light source portion 3 comprises a plate-shaped light source substrate 31 extending substantially parallel to the rear surface 22 of the light guiding plate 2 and having a front surface 31a and a rear surface 31b; and the light source 32 provided on the light source substrate 31 so as to face the end face 23 of the light guiding plate 2.

The light source substrate 31 is a substrate to support the light source 32. The light source substrate 31 has the front surface 31a of the light source substrate 31 provided facing the rear surface 22 of the light guiding plate 2 in a substantially parallel manner along at least one side of the light guiding plate 2. Between the rear surface 22 of the light guiding plate 2 and the front surface 31a of the light source substrate 31, a sheet-shaped member such as the reflecting plate 6 may be interposed, as in the embodiment, or the rear surface 22 of the light guiding plate 2 and the front surface 31a of the light source substrate 31 may be in direct contact with each other without the reflecting plate 6 being provided. The light source substrate 31 may be provided over the entire rear surface 22 of the light guiding plate 2, or, as shown in FIG. 2, the light source substrate 31 may be provided so as to overlap a part of the rear surface 22 of the light guiding plate 2 in a band-shaped region provided in a predetermined width from one side of the rear surface 22 of the light guiding plate 2.

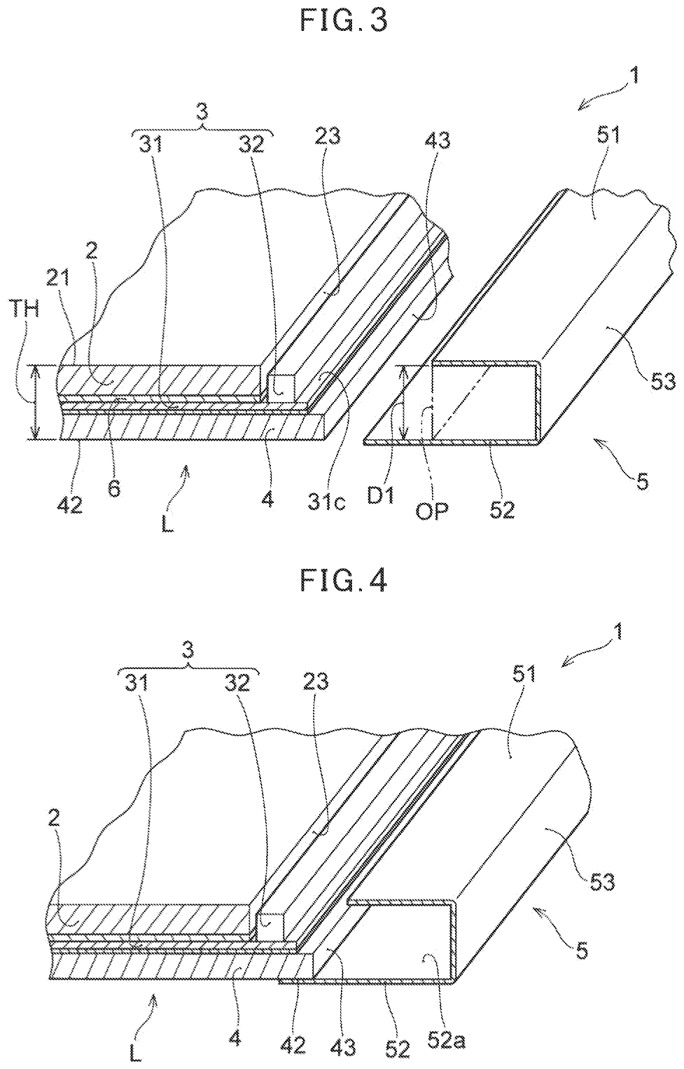

As shown in FIGS. 2 and 3, the light source substrate 31 has a light source supporting portion 31c not overlapping the light guiding plate 2, which light source supporting portion 31c extends outward with respect to the end face 23 of the light guiding plate 2. A predetermined number of the light sources 32 are provided on the light source supporting portion 31c along the end face 23 of the light guiding plate 2. The light sources 32 are projecting in a direction perpendicular to the front surface 31a of the light source substrate 31. While an LED light source, for example, may be used as the light source 32, the light source 32 is not limited to the LED light source, so that other light sources such as a fluorescent tube may be used.

According to the embodiment, the backlight apparatus 1 has a mounting portion to restrict relative movement between the light guiding plate 2 and the light source 32 in a direction perpendicular to the end face 23 of the light guiding plate 2 to suppress positional displacement between the light source 32 provided on the light source substrate 31 and the end face 23 of the light guiding plate 2.

Moreover, the rear surface 31b of the light source substrate 31 is provided facing a front surface 41 of the backlight chassis 4. While a method of mounting of the light source substrate 31 to the backlight chassis 4 is not particularly limited, the light source substrate 31 is preferably mounted via a mounting portion A such that no positional displacement of the light source substrate 31 occurs with respect to the backlight chassis 4. As shown in FIG. 2, according to the embodiment, the mounting portion A is an adhesive layer such as a double-sided tape or an adhesive material, which adhesive layer adheres the rear surface 31b of the light source substrate 31 and the front surface 41 of the backlight chassis 4 to each other. The mounting portion A may be an engaging portion to engage the light source substrate 31 to the backlight chassis 4 to suppress the relative movement thereof.

The backlight chassis 4 is provided in the rear of the light guiding plate 2 and the light source portion 3. As shown in FIG. 2, the backlight chassis 4 is arranged facing the rear surface 31b of the light source substrate 31 and has the front surface 41 and a rear surface 42. According to the embodiment, the front surface 41 of the backlight chassis 4 is provided facing the rear surface 31b of the light source substrate 31 and facing the rear surface 22 of the light guiding plate 2 (a rear surface of the reflecting plate 6) in a region in which the light source substrate 31 is not provided. The backlight chassis 4 is made of a material such as a metal material having the rigidity being higher than that of the light guiding plate 2, the reflecting plate 6, or the light source substrate 31. In this case, when the light guiding plate 2, the reflecting plate 6, and the light source substrate 31 stacked on the backlight chassis 4 are sandwiched by the fixing member 5, the backlight chassis 4 functions as a rigid supporting body, making it possible to suppress warping at end portions of the light guiding plate 2, the reflecting plate 6, and the light source substrate 31.

Moreover, as shown in FIG. 2, in a case that the light source substrate 31 is provided so as to overlap a part of the rear surface 22 of the light guiding plate 2 in a belt-shaped region provided with a predetermined width from one side of the rear surface 22 of the light guiding plate 2, a stepped portion ST is generated in the thickness direction of the light guiding plate 2 between the rear surface 22 of the light guiding plate 2 (the rear surface of the reflecting plate 6) and the light source substrate 31. On the other hand, according to the embodiment, the backlight chassis 4 has a protruding portion 41a protruding toward the rear surface 22 of the light guiding plate 2 as shown in FIG. 2 in a region in which the light guiding plate 2 and the light source substrate 31 do not overlap. The protruding portion 41a protrudes with a height corresponding to the height of the stepped portion ST with respect to the front surface 41 of the backlight chassis 4 in a region overlapping the light guiding plate 2. The backlight chassis 4 having the protruding portion 41a causes the front surface 41 of the backlight chassis 4 and the rear surface 22 of the light guiding plate 2 (or the rear surface of the reflecting plate 6) to abut each other even in a region in which the light guiding plate 2 and the light source substrate 31 do not overlap. Therefore, in the region in which the light guiding plate 2 and the light source substrate 31 do not overlap, the flexure of the light guiding plate 2 and the reflecting plate 6 in the thickness direction of the light guiding plate 2 is suppressed. The protruding portion 41a may be configured such that the entire region not overlapping the light source substrate 31 of the backlight chassis 4 abuts or partially abuts the rear surface of the light guiding plate 2 or the reflecting plate 6.

A lateral wall (not shown) extending perpendicularly to the front surface 41 is formed at a side of the backlight chassis 4 other than a side thereof extending along the light source 32. On the other hand, at the side of the backlight chassis 4 extending along the light source 32, as shown in FIGS. 2 and 3, the lateral wall extending perpendicularly to the front surface 41 is not formed.

As shown in FIG. 2, the fixing member 5 sandwiches and fixes the light guiding plate 2, the light source substrate 31, and the backlight chassis 4 in the thickness direction of the light guiding plate 2. As described below, the fixing member 5 is mounted to the layered structure (below called merely a layered body L; see FIG. 3) including the light guiding plate 2, the light source substrate 31, and the backlight chassis 4. The fixing member 5 is mounted to the layered body L in a direction parallel to the front surface 21 of the light guiding plate 2 from an end portion (side) at which the light source 32 is provided. In this way, the layered body L is sandwiched in the thickness direction of the light guiding plate 2 and fixed.

According to the embodiment, as shown in FIGS. 2 to 5, the fixing member 5 has a first sandwiching portion 51 facing the front surface 21 of the light guiding plate 2; a second sandwiching portion 52 facing the rear surface 42 of the backlight chassis 4; and a connecting portion 53 connecting the first sandwiching portion 51 and the second sandwiching portion 52. As shown in FIG. 2, the first sandwiching portion 51 is formed in a shape of a plate having a front surface 51a and a rear surface 51b. The second sandwiching portion 52 is formed in a shape of a plate having a front surface 52a and a rear surface 52b. The connecting portion 53 is formed in a shape of a plate having an inner surface 53a and an outer surface 53b. The first sandwiching portion 51 and the second sandwiching portion 52 extend in parallel with each other, while the connecting portion 53 extends substantially perpendicularly to the first sandwiching portion 51 and the second sandwiching portion 52. In this way, the cross-sectional shape of the fixing member 5 is formed in a substantial U-shape by the first sandwiching portion 51, the second sandwiching portion 52, and the connecting portion 53.

A length L1 (see FIG. 2) from the connecting portion 53 to a tip 51c of the first sandwiching portion 51 is greater than a length L2 (see FIG. 2) from the end face 43 of the backlight chassis 4 to the end face 23 of the light guiding plate 2. While a length L3 (see FIG. 2) from the connecting portion 53 to a tip 52c of the second sandwiching portion 52 is not particularly limited as long as the layered body L may be sandwiched along with the first sandwiching portion 51, in the same manner as the first sandwiching portion 51, it is preferably greater than the length L2 from the end face 43 of the backlight chassis 4 to the end face 23 of the light guiding plate 2.

According to the embodiment, the length L3 from the connecting portion 53 to the tip 52c of the second sandwiching portion 52 is greater than the length L1 from the connecting portion 53 to the tip 51c of the first sandwiching portion 51. In this case, as shown in FIG. 4, this makes it easier to place the layered body L into the space between the first sandwiching portion 51 and the second sandwiching portion 52 from an opening OP while the rear surface 42 of the backlight chassis 4 is guided along the front surface 52a of the second sandwiching portion 52. Therefore, the fixing member 5 can be easily mounted to the layered body L.

The fixing member 5 is not limited to being formed in a substantial U-shape as long as the layered body L can be sandwiched in the thickness direction of the light guiding plate 2. Therefore, the fixing member 5 may have an additional part in addition to the first sandwiching portion 51, the second sandwiching portion 52, and the connecting portion 53. For example, the fixing member 5 may have an extending portion extending in a direction opposite to the extending direction of the first sandwiching portion 51 from an intersection between the first sandwiching portion 51 and the connecting portion 53, or may have an extending portion extending in a direction opposite to the extending direction of the second sandwiching portion 52 from an intersection between the second sandwiching portion 52 and the connecting portion 53.

According to the embodiment, as shown in FIG. 3, the fixing member 5 is formed in an elongated rail shape along the light source 32. The fixing member 5 has the opening OP (see the chain double-dashed line in FIG. 3) to be an insertion opening when a part of the light guiding plate 2, the light source substrate 31, and the backlight chassis 4 is inserted between the first sandwiching portion 51 and the second sandwiching portion 52 facing each other. In a case that the length from the connecting portion 53 to the first sandwiching portion 51 and the length from the connecting portion 53 to the second sandwiching portion 52 are different, the opening OP refers to an opening formed between the tip of one sandwiching portion having a shorter length from the connecting portion 53 and a front surface or a rear surface of the other sandwiching portion facing the one sandwiching portion having the shorter length therefrom. According to the embodiment, the opening OP is an opening formed between the tip 51c of the first sandwiching portion 51 and the front surface 52a of the second sandwiching portion 52. In a case that the length from the connecting portion 53 to the first sandwiching portion 51 and the length from the connecting portion 53 to the second sandwiching portion 52 are the same, the opening OP is to be an opening formed between the tip 51c of the first sandwiching portion 51 and the tip 52c of the second sandwiching portion 52.

A separation distance D1 (see FIG. 3) between the first sandwiching portion 51 and the second sandwiching portion 52 at a position of the opening OP is preferably equal to a thickness TH (see FIG. 3) from the front surface 21 of the light guiding plate 2 to the rear surface 42 of the backlight chassis 4, or less than the thickness TH (D1≤TH). In this case, when the layered body L is fixed by the fixing member 5, a gap between the first sandwiching portion 51 and the front surface 21 of the light guiding plate 2 and between the second sandwiching portion 52 and the rear surface 42 of the backlight chassis 4 is unlikely to occur. Therefore, light leakage can be suppressed when the fixing member 5 is fixed to the layered body L.

While the material for fixing member 5 is not particularly limited, it is preferably made of an elastically deformable material, for example. The fixing member 5 is made of a metal, or a synthetic resin having a predetermined rigidity, for example. The fixing member 5 being made of the elastically deformable material allows the first sandwiching portion 51 and the second sandwiching portion 52 to be deformed to make mounting easier when the layered body L is sandwiched between the first sandwiching portion 51 and the second sandwiching portion 52.

Next, one example of a fixing method when the fixing member 5 is fixed to the layered body L in the backlight apparatus 1 of the embodiment is explained. The fixing method below is merely one example, so that the invention is not limited by the explanations below.

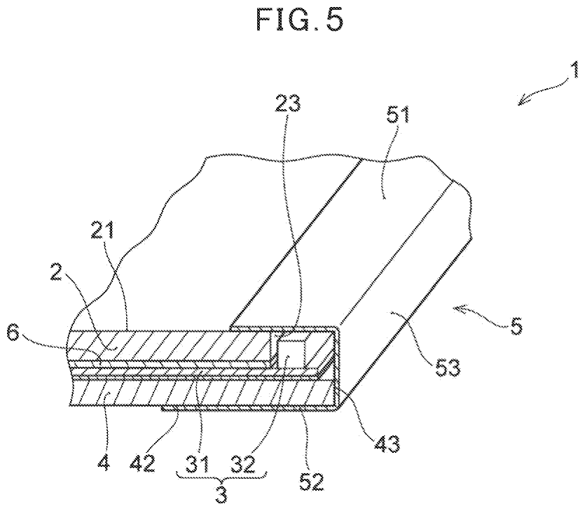

First, as shown in FIG. 3, the light guiding plate 2 (the reflecting plate 6), the light source substrate 31, and the backlight chassis 4 are stacked in the thickness direction of the light guiding plate 2 to form the layered body L. With respect to this layered body L, as shown in FIGS. 4 and 5, the fixing member 5 is moved toward the layered body L (or the layered body L is moved toward the fixing member 5) so that the layered body L is placed between the first sandwiching portion 51 and the second sandwiching portion 52 from the opening OP. As described above, according to the embodiment, the length L3 (see FIG. 2) from the connecting portion 53 to the tip 52c of the second sandwiching portion 52 is greater than the length L1 (see FIG. 2) from the connecting portion 53 to the tip 51c of the first sandwiching portion 51. In this case, the fixing member 5 can be moved with the rear surface 42 of the backlight chassis 4 being slid and guided along the front surface 52a of the second sandwiching portion 52. Therefore, the fixing member 5 can be easily mounted to the layered body L. When the fixing member 5 is moved from the state in FIG. 4 to the state in FIG. 5, the end face 43 of the backlight chassis 4 being projected further than the light source substrate 31 with respect to the end face 23 of the light guiding plate 2 facing the light source 32 abuts the inner surface of the connecting portion 53 of the fixing member 5, completing mounting of the fixing member 5.

When the fixing member 5 is mounted to the layered body L, the fixing member 5 can fix and sandwich the layered body L in the thickness direction of the light guiding plate 2. In this way, fixing of the light guiding plate 2, the light source substrate 31, and the backlight chassis 4 is completed by only assembling the fixing member 5 to the layered body L, making it possible to improve the workability at the time of assembling of components of the backlight apparatus 1. Moreover, the light source substrate 31 is sandwiched from both sides in the thickness direction of the light guiding plate 2 between the light guiding plate 2 and the backlight chassis 4. Therefore, positional displacement between the light guiding plate 2 and the light source 32 is unlikely to occur, and making it possible to suppress change of distance and angle of the optical axis of the light source 32 with respect to the end face 23 of the light guiding plate 2. Furthermore, the light guiding plate 2 and the light source substrate 31 are supported substantially parallel to the backlight chassis 4 with high rigidity, so that warping at the end portions of the light guiding plate 2 and the light source substrate 31 is suppressed. Therefore, displacement of the optical axis of the light source 32 due to warping of the light guiding plate 2 and the light source substrate 31 can be suppressed. According to the embodiment, the fixing member 5 is made of an elastically deformable material, and the layered body L is sandwiched and pressed by the first sandwiching portion 51 and the second sandwiching portion 52. In this case, the light source substrate 31 being pressed from both sides in the thickness direction allows further suppressing positional displacement of the light source 32 with respect to the light guiding plate 2. Furthermore, a gap is unlikely to be generated between the first sandwiching portion 51 and the front surface 21 of the light guiding plate 2 and between the second sandwiching portion 52 and the rear surface 42 of the backlight chassis 4, making it possible to suppress light from the light source 32 from leaking.

### Embodiment 2

Next, a backlight apparatus according to Embodiment 2 of the invention will be explained. Those points explained in each configuration of Embodiment 1 may also be applied in a similar manner to the backlight apparatus according to Embodiment 2.

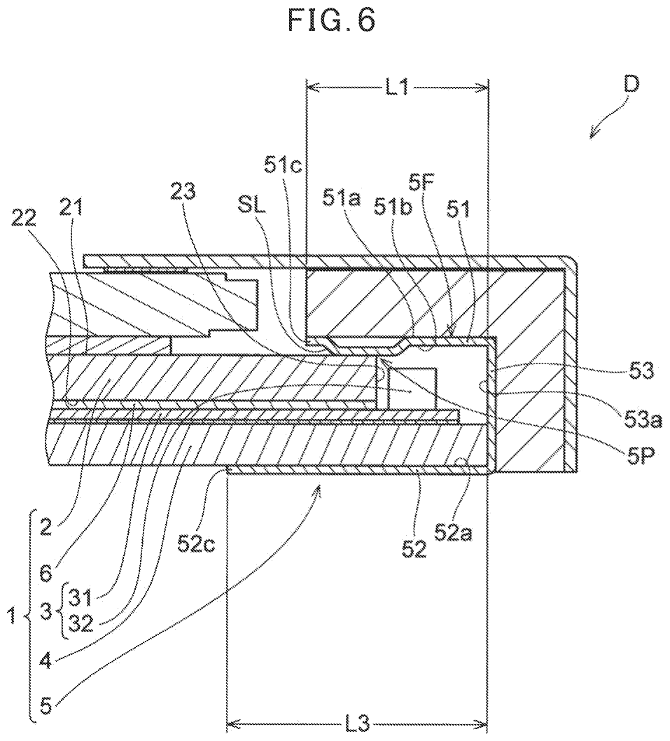

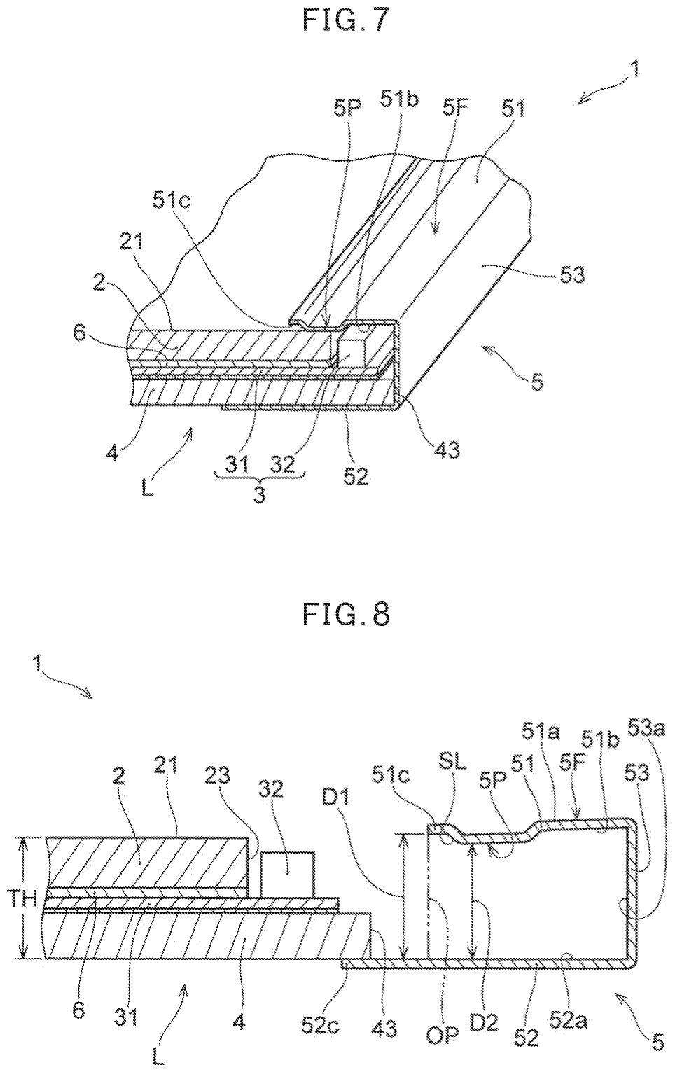

As shown in FIGS. 6 and 7, the embodiment is different from Embodiment 1 in that a part of a rear surface 51b of a first sandwiching portion 51 of a fixing member 5 is bent. While an aspect in which only a part of the rear surface 51b of the first sandwiching portion 51 is bent is shown according to the embodiment, it suffices that at least a part of the rear surface 51b of the first sandwiching portion 51 be bent. Moreover, at least a part of the rear surface 51b of the first sandwiching portion 51 may be curved.

According to the embodiment, as shown in FIGS. 6 and 7, the first sandwiching portion 51 has a projecting portion 5P being bent a plurality of times from a connecting portion 53 to a tip 51c of the first sandwiching portion 51, and projecting toward a second sandwiching portion 52 facing the first sandwiching portion 51. The projecting portion 5P is provided at a position being in contact with the front surface 21 of the light guiding plate 2 when the fixing member 5 is mounted to the layered body L. As shown in FIG. 7, the projecting portion 5P is formed continuously in the longitudinal direction of the fixing member 5 (the direction along a light source 32) and is configured such that a gap is prevented from being generated in the longitudinal direction between the first sandwiching portion 51 and the front surface 21 of the light guiding plate 2.

According to the embodiment, a first separation distance D1 (see FIG. 8) between the first sandwiching portion 51 and the second sandwiching portion 52 at a position of the opening OP is greater than a thickness TH (see FIG. 8) from the front surface 21 of the light guiding plate 2 to a rear surface 42 of a backlight chassis 4. Moreover, as the first sandwiching portion 51 is bent (or curved), a second separation distance D2 (see FIG. 8) between the first sandwiching portion 51 and the second sandwiching portion 52 in an intermediate region between the opening OP and the connecting portion 53 is less than the thickness TH from the front surface 21 of the light guiding plate 2 to the rear surface 42 of the backlight chassis 4.

The first separation distance D1 is a distance between the first sandwiching portion 51 and the second sandwiching portion 52 at a position of the opening OP. According to the embodiment, the first separation distance D1 is a distance between the tip 51c of the first sandwiching portion 51 and a front surface 52a of the second sandwiching portion 52. Unlike the embodiment, in a case that a length L1 (see FIG. 6) of the first sandwiching portion 51 is greater than a length L3 (see FIG. 6) of the second sandwiching portion 52, the first separation distance D1 is a distance between a tip 52c of the second sandwiching portion 52 and the rear surface 51b of the first sandwiching portion 51, while, in a case that the length L1 of the first sandwiching portion 51 is the same as the length L3 of the second sandwiching portion 52, the first separation distance D1 is a distance between the tip 51c of the first sandwiching portion 51 and the tip 52c of the second sandwiching portion 52.

The second separation distance D2 refers to a distance between the first sandwiching portion 51 and the second sandwiching portion 52 with shortest distance in an intermediate region between the first sandwiching portion 51 and the connecting portion 53. Specifically, the second separation distance D2 is a distance in a portion having the shortest distance between the projecting portion 5P of the first sandwiching portion 51 and the front surface 52a of the second sandwiching portion 52.

Next, one example of a fixing method when the fixing member 5 is fixed to the layered body L in a backlight apparatus 1 according to the embodiment is explained. The fixing method below is merely one example, so that the invention is not limited by the explanations below.

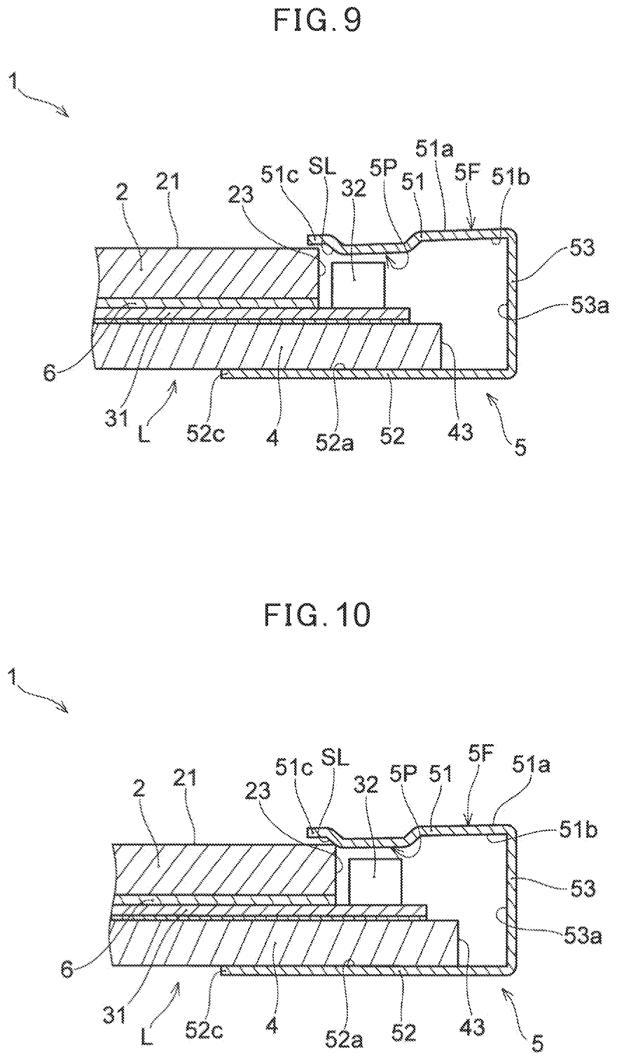

First, as shown in FIG. 8, the light guiding plate 2 (a reflecting plate 6), a light source substrate 31, and the backlight chassis 4 are stacked in the thickness direction of the light guiding plate 2 to form the layered body L. With respect to this layered body L, as shown in FIG. 9, the fixing member 5 (or the layered body L) is moved so that the layered body L is placed between the tip 51c of the first sandwiching portion 51 and the front surface 52a of the second sandwiching portion 52 from the opening OP. According to the embodiment, the first separation distance D1 between the first sandwiching portion 51 and the second sandwiching portion 52 at a position of the opening OP is greater than the thickness TH from the front surface 21 of the light guiding plate 2 to the rear surface 42 of the backlight chassis 4. In this way, as shown in FIG. 9, it is suppressed that an end face 23 of the light guiding plate 2 or the corner portion between the front surface 21 and the end face 23 of the light guiding plate 2 comes into contact with the tip 51c of the first sandwiching portion 51 when the light guiding plate 2 of the layered body L is placed into the opening OP. Therefore, scraping of the light guiding plate 2 or damage of the fixing member 5 due to the tip 51c of the first sandwiching portion 51 coming into contact with the end face 23 or the corner portion of the light guiding plate 2 is suppressed.

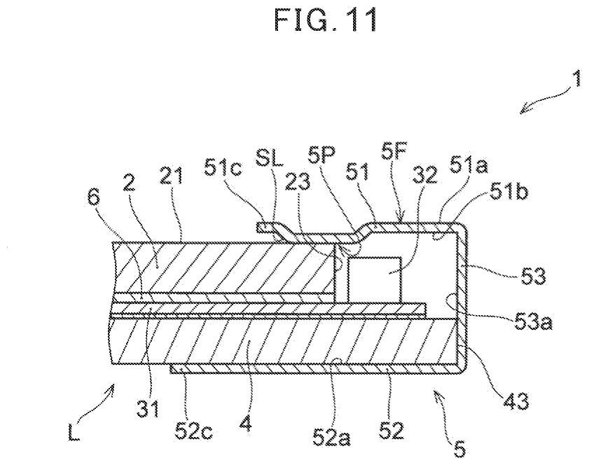

Moreover, according to the embodiment, a second separation distance D2 between the first switching portion 51 and the second switching portion 52 is less than the thickness TH from the front surface 21 of the light guiding plate 2 to the rear surface 42 of the backlight chassis 4. Accordingly, when the fixing member 5 is moved from the state in FIG. 9 to the state in FIG. 10 with respect to the layered body L, the first sandwiching portion 51 or the second sandwiching portion 52 deflects with an intersection between the connecting portion 53 and the first sandwiching portion 51 or the second sandwiching portion 52 as a fulcrum to increase the second separation distance D2 between the first sandwiching portion 51 and the second sandwiching portion 52. As shown in FIG. 11, when the fixing member 5 is further moved from the state in FIG. 10, the end face 43 of the backlight chassis 4 abuts an inner surface 53a of the connecting portion 53 of the fixing member 5, completing mounting of the fixing member 5. According to the embodiment, as described above, at a position of the opening OP, the first separation distance D1 is greater than the thickness TH of the layered body L, and the second separation distance D2 in a region of the projecting portion 5P is less than the thickness TH of the layered body L. Therefore, even when a dimension error in the thickness direction of the layered body L occurs in components of the backlight apparatus 1, the fixing member 5 can be easily mounted to the layered body L without damaging the light guiding plate 2 or the fixing member 5. Moreover, the second separation distance D2 is configured to be less than the thickness TH of the layered body L, making it possible to sandwich the layered body L with a pressing force being applied thereto in the thickness direction. Therefore, the backlight apparatus 1 according to the embodiment makes it possible to fix the layered body L with no rattling in the thickness direction between the layered body L and the fixing member 5 and makes it possible to suppress light leakage from in between the fixing member 5 and the light guiding plate 2.

Moreover, according to the embodiment, the projecting portion 5P has an inclined surface SL on the tip 51c side of the first sandwiching portion 51, which inclined surface SL is inclined such that the separation distance from the inclined surface SL to the second sandwiching portion 52 gradually decreases. In this way, as shown in FIG. 10, when the fixing member 5 moves in the direction in which the connecting portion 53 of the fixing member 5 and the end face 23 of the light guiding plate 2 approach each other from a state in which the corner portion of the light guiding plate 2 is coming into contact with the inclined surface SL, the first sandwiching portion 51 or the second sandwiching portion 52 deflects so as to increase the separation distance therebetween due to a force applied to the inclined surface SL from the corner portion of the light guiding plate 2. Therefore, pushing the fixing member 5 with respect to the layered body L in a direction parallel to the front surface 21 of the light guiding plate 2 makes it possible to easily mount the fixing member 5 to the layered body L.

Furthermore, according to the embodiment, the front surface Sla of the first sandwiching portion 51 has a flat portion 5F. The front surface 51a of the first sandwiching portion 51 having the flat surface 5F allows completing assembling of the panel chassis PS to the backlight apparatus 1 merely by placing the panel chassis PS on the flat surface 5F when the panel chassis PS is assembled to the backlight apparatus 1 (the layered body L to which the fixing member 5 is mounted) as shown in FIG. 6. According to the embodiment, the flat portion 5F of the front surface 51a of the first sandwiching portion 51 is configured to be substantially parallel to the front surface 21 of the light guiding plate 2 or the rear surface 42 of the rear chassis 4 when the fixing member 5 is mounted to the layered body L.

While explanations have been made with reference to an example in which the first sandwiching portion 51 is bent and the projecting portion 5P is provided in the first sandwiching portion 51 according to the embodiment, at least a part of the front surface 52a of the second sandwiching portion 52 (not the first sandwiching portion 51) may be curved or bent, and the projecting portion 5P may be provided to the second sandwiching portion 52. Moreover, both of the rear surface 51b of the first sandwiching portion 51 and the front surface 52a of the second sandwiching portion 52 may be curved or bent and the projecting portion 5P are provided to both of the first sandwiching portion 51 and the second sandwiching portion 52.

### CONCLUSION

(1) A backlight apparatus according to aspect 1 of the invention comprises a light guiding plate having a front surface, a rear surface, and an end face connecting the front surface and the rear surface; a light source portion comprising a plate-shaped light source substrate extending substantially parallel to the rear surface of the light guiding plate and having a front surface and a rear surface, and a light source provided on the light source substrate so as to face the end face of the light guiding plate; a backlight chassis arranged facing the rear surface of the light source substrate and having a front surface and a rear surface; and a fixing member to sandwich and fix the light guiding plate, the light source substrate, and the backlight chassis in a thickness direction of the light guiding plate.

(2) In the backlight apparatus according to (1), the fixing member may have a first sandwiching portion facing the front surface of the light guiding plate; a second sandwiching portion facing the rear surface of the backlight chassis; and a connecting portion connecting the first sandwiching portion and the second sandwiching portion.

(3) In the backlight apparatus according to (2), a length from the connecting portion to a tip of the second sandwiching portion may be greater than a length from the connecting portion to a tip of the first sandwiching portion.

(4) In the backlight apparatus according to (2) or (3), the fixing member may have an opening to be an insertion opening when a part of the light guiding plate, the light source substrate, and the backlight chassis is inserted between the first sandwiching portion and the second sandwiching portion facing each other; and at least a part of a rear surface of the first sandwiching portion and/or at least a part of a front surface of the second sandwiching portion of the fixing member may be curved or bent such that a first separation distance between the first sandwiching portion and the second sandwiching portion at a position of the opening is greater than a thickness from the front surface of the light guiding plate to the rear surface of the backlight chassis; and a second separation distance between the first sandwiching portion and the second sandwiching portion in an intermediate region between the opening and the connecting portion is less than the thickness from the front surface of the light guiding plate to the rear surface of the backlight chassis.

(5) In the backlight apparatus according to (4), at least the part of the rear surface of the first sandwiching portion may be curved or bent and a front surface of the first sandwiching portion can have a flat portion.

(6) In the backlight apparatus according to (4), at least the part of the front surface of the second sandwiching portion may be curved or bent and a rear surface of the second sandwiching portion can have a flat portion.
1 BACKLIGHT APPARATUS
2 LIGHT GUIDING PLATE
21 FRONT SURFACE
22 REAR SURFACE
23 END FACE
3 LIGHT SOURCE PORTION
31 LIGHT SOURCE SUBSTRATE
31a FRONT SURFACE
31b REAR SURFACE
31c LIGHT SOURCE SUPPORTING PORTION
32 LIGHT SOURCE
4 BACKLIGHT CHASSIS
41 FRONT SURFACE
41a PROTRUDING PORTION
42 REAR SURFACE
43 END FACE
5 FIXING MEMBER
51 FIRST SANDWICHING PORTION
51a FRONT SURFACE
51b REAR SURFACE
51c TIP
52 SECOND SANDWICHING PORTION
52a FRONT SURFACE
52b REAR SURFACE
52c TIP
53 CONNECTING PORTION
53a INNER SURFACE
53b OUTER SURFACE
5F FLAT PORTION
5P PROJECTING PORTION
6 REFLECTING PLATE
A MOUNTING PORTION
B BEZEL
Ba FRAME PORTION
Bb LATERAL WALL PORTION
C CUSHIONING MEMBER
D DISPLAY APPARATUS
FC FRONT CABINET
L LAYERED BODY
OP OPENING
P DISPLAY PANEL
PS PANEL CHASSIS
PS1 FRONT PORTION
PS2 LATERAL PORTION
RC REAR CABINET
S OPTICAL SHEET
SL INCLINED SURFACE
ST STEPPED PORTION

1. A backlight apparatus comprising:
a light guiding plate having a front surface, a rear surface, and an end face connecting the front surface and the rear surface;
a light source portion comprising a plate-shaped light source substrate extending substantially parallel to the rear surface of the light guiding plate and having a front surface and a rear surface, and a light source provided on the light source substrate so as to face the end face of the light guiding plate;
a backlight chassis arranged facing the rear surface of the light source substrate and having a front surface and a rear surface; and
a fixing member to sandwich and fix the light guiding plate, the light source substrate, and the backlight chassis in a thickness direction of the light guiding plate, wherein
the fixing member has
a first sandwiching portion having a first portion facing the front surface of the light guiding plate, at least a part of the first portion being in contact with the front surface of the light guiding plate;
a second sandwiching portion having a second portion facing the rear surface of the backlight chassis, at least a part of the second portion being in contact with the rear surface of the backlight chassis; and
a connecting portion connecting the first sandwiching portion and the second sandwiching portion.

2. (canceled)

3. The backlight apparatus according to claim 1, wherein
a length from the connecting portion to a tip of the second sandwiching portion is greater than a length from the connecting portion to a tip of the first sandwiching portion.

4. The backlight apparatus according to claim 1, wherein
the fixing member has an opening to be an insertion opening when a part of the light guiding plate, the light source substrate, and the backlight chassis is inserted between the first sandwiching portion and the second sandwiching portion facing each other; and
a first separation distance between the first sandwiching portion and the second sandwiching portion at a position of the opening is greater than a thickness from the front surface of the light guiding plate to the rear surface of the backlight chassis; and
a second separation distance between the first sandwiching portion and the second sandwiching portion in an intermediate region between the opening and the connecting portion is less than the thickness from the front surface of the light guiding plate to the rear surface of the backlight chassis.

5. The backlight apparatus according to claim 4, wherein
at least a part of a rear surface of the first sandwiching portion and/or at least a part of a front surface of the second sandwiching portion is curved or bent.

6. The backlight apparatus according to claim 5, wherein
at least the part of the front surface of the second sandwiching portion is curved or bent and a rear surface of the second sandwiching portion has a flat portion.

7. The backlight apparatus according to claim 5, wherein
at least the part of the rear surface of the first sandwiching portion is curved or bent and a front surface of the first sandwiching portion has a flat portion.
